(19) United States
(12) Patent Application Publication
(10) Pub. No.: US 2022/0087303 A1
(43) Pub. Date: Mar. 24, 2022

(54) EXTRUDER TO NIXTAMALIZE MAIZE FRACTIONS

(71) Applicant: CARLOS SANTAMARIA PEREZ, Los Mochis (MX)

(72) Inventor: CARLOS SANTAMARIA PEREZ, Los Mochis (MX)

(21) Appl. No.: 17/341,194

(22) Filed: Jun. 7, 2021

(30) Foreign Application Priority Data
Sep. 18, 2020 (MX) MX/E/2020/053298

(51) Int. Cl. A23P 30/20; A23L 7/10

(52) U.S. Cl. CPC A23P 30/20; A23V 2002/00; A23L 7/197

(57) ABSTRACT

The present utility model “Extruder to nixtamalize maize fractions” aims to provide and extruder to nixtamalize maize fractions previously conditioned with water and food grade lime, eliminating the production of nejayote in the production of nixtamalized maize flour, as well as the reduction of clogging of the extruded material. In addition to the aforementioned, it's easy to assemble for cleaning.

### CROSS-REFERENCE TO RELATED APPLICATIONS

“Not applicable”

### BACKGROUND OF THE INVENTION

Extrusion is a continuous process that combines heat and mechanical stress to provoke the gelatinization of the starch granules, the inactivation of enzymes that affect shelf life, the destruction of nonnutritive compounds, and the drastic or total elimination of microorganisms in the product (Justo-Torres and Pérez, 2006). Extrusion has been employed in obtaining products from cereals and textured vegetable proteins. The advantages of this technology are good nutritional and microbiological quality of the products yielded, in addition to allowing control of the water activity and food stability. Adding to the abovementioned, it takes place inside a compact equipment, which wastes little energy and requires only a small amount of space (Justo-Torres and Pérez, 2006). With respect to the advantages of extrusion above other technologies, it can be emphasized that this process reaches an efficient transfer of energy between the dough and a high temperature (the cooking process of the product takes place in a short amount of time, between 10 s and 60 s). In addition, it possesses a great capacity of production with a low capital investment (Justo-Torres and Pérez, 2006). Maize is the cereal grain most commonly used for extrusion due to its low cost and ability to expand. However, nixtamalized maize flour production through the use of extruders has not been able to be taken to an industrial and commercial level, to comply with the palate of the final consumers. Nixtamalization is the process by which maize is cooked with water and food grade lime. In this process, nixtamal and nejayote are obtained. After being milled, the nixtamal gives rise to the nixtamalized dough, while the nejayote is the alkaline broth (residue) that contains husks, maize starches, and other substances that are discarded. The production of nixtamalized maize flours yields nejayote. The literature mentions the following relation, from one processed maize ton it's estimated that three cubic meters of water are required, the production of nejayote requires around 50 million cubic meters (Scheel, 2016). If nejayote isn't treated, it can generate environmental pollution due to its high pH and high concentrations of organic matter and calcium hydroxide. In addition to this, one of the most common problems in an extrusion process is clogging, that take place inside of the cylinder, also known as barrel or cannon. This occurs when treating the material with the screws. As a consequence, the equipment must be stopped and cleaned, reducing the effective time of operation. With the end of producing doughs and maize flours to make tortillas, extruders have been used as part of the nixtamalization processes to reduce or eliminate the production of nejayote, which have different configurations that include the extrusion of the maize grain.

In such a manner, the following devices may be cited:

I.—The state of the technique of the patent application MX/a/2017/006193 an extruder of swivel tip that incorporates a system of double worm drives, instead of the single worm drive typically used, to create extruded products. Additionally, it features a transition piece at the extreme underneath the worm drive which allows for the continuous and uniform flow into the assembly die, where the cooking takes place. In contrast to the abovementioned patent application, the present invention features a different configuration of the screws. The screws in the present invention features a thread uniform in width and depth, but the spacing between the threads is different in longitude and angle, this differences in the screws generate sections of transport, mixing and compression in the barrel. This arrangement of the screws brings the following advantages: the material flows in a short time, the cutting force (friction) and the pressure on the back of the die are reduced. In addition, it brings a low temperature to the output of the extruder without expanding the material. Another advantage that the present invention possesses in contrast to the abovementioned patent application is that the barrel is divided in sections to facilitate the cleaning of the parts and its mounting reduces clogging cleaning times. The last advantage to be mentioned is that the die of the present invention has a large orifice which helps the material to flow in a short amount of time, reducing the cutting force (friction) and the pressure on the back of the die, maintaining a low output temperature without expanding the material.

II.—The state of the technique of the Mexican patent with number PA/a/1993/006544 which describes an extrusion equipment and the continuous process that takes place in this equipment to elaborate fresh dough used in the production of instant flour tortillas and its derivatives. The raw maize (whole-grain or decorticated) of any genotype, food grade lime and water are used as source materials. This mixture is processed in a low shearing extruder to produce fresh dough with appropriate characteristics to be directly used in the production of tortillas and its derivatives, or through the stages of drying grinding and screening to obtain instant flours, this are rehydrated and employed in the production of tortillas and its derivatives. The residence times for obtaining fresh dough are approximately 1.5 minutes with temperatures between 70° C. and 90° C. in the heating zone. The aforementioned patent is a production process for fresh dough, in contrast with the present invention which is and extruder to produce extrudate of nixtamalized maize fractions, conditioned with water and food grade lime. Additionally, the extruder employed in the aforementioned patent is different as the screws in the present invention feature threads uniform in width and depth, but the spacing between the threads is different in longitude and angle, this differences in the screws generate sections of transport, mixing and compression in the barrel. This arrangement of the screws brings the following advantages: the material flows in a short time, the cutting force (friction) and the pressure on the back of the die are reduced. In addition, it brings a low temperature to the output of the extruder without expanding the material. Another advantage that the present invention possesses in contrast to the abovementioned patent application is that the barrel is divided in sections to facilitate the cleaning of the parts and its mounting reduces clogging cleaning times. The last advantage to be mentioned is that the die of the present invention has a large orifice which helps the material to flow in a short amount of time, reducing the cutting force (friction) and the pressure on the back of the die, maintaining a low output temperature without expanding the material.

III.—The state of the technique of the Mexican patent PA/a/2002/009998 refers to and extruder with a worm drive for making cattle feed from agricultural residues, which comprises a mobile mechanical arrangement based on a mechanical transmission system coupled to an extrusion system, wherein said transmission system is integrated by any driving force coupled to a transmission shaft, a gearbox, which successfully connects to a roller chain and chainwheels transmission that provide the driving force to the extruder wherein said extruder comprises a feed hopper assembly, leadscrew elements, barrel, die, cutting mechanism and bearing box, the extruder being characterized by a leadscrew based on two sections, one for feeding and another for compression, wherein said leadscrew comprises a radially extending beaded element joining a helix at the tip and where the compression zone of said leadscrew is made up of five helixes with decreasing sharpening of 6.9° and the initial diameter of the helixes is 177.8 mm with a variable step that starts at 101.6 mm and ends at 50.8 mm and the diameter of the final helix is 92 mm, the angle of the helix is up to 17° and is preferably between 10° and 13°, which allows transport of the biomass without clogging. The aforementioned patent has the novelty of a mechanical transmission system coupled to an extruder, that has a leadscrew with two sections in contrast of the present invention which features two screws with four sections with different spacing between threads and angle. In addition, the barrel is divided in sections to facilitate the cleaning of the parts and its mounting reducing clogging cleaning times.

IV.—The state of the technique of the patent application WO 2017/012625 refers to an extruder designed to produce meat substitute products, where the extruder comprises an input and an output of the products, a longitudinal barrel that comprises an internal surface, an external surface, wherein the extruder further comprises heating means for heating at least a part of said internal surface, wherein said barrel interconnects to said input and output of the product, wherein the extruder further comprises a rotor coaxially arranged within said barrel, wherein said rotor comprises traction means to rotate said rotor in relation to the barrel. The aforementioned patent application features heating means to heat the internal surface, the differences with the present invention are found in the configuration of the screws in the present invention, as they feature threads uniform in width and depth, but the spacing between the threads is different in longitude and angle, this differences in the screws generate sections of transport, mixing and compression in the barrel. This arrangement of the screws brings the following advantages: the material flows in a short time, the cutting force (friction) and the pressure on the back of the die are reduced. In addition, it brings a low temperature to the output of the extruder without expanding the material. Another advantage that the present invention possesses in contrast to the abovementioned patent application is that the barrel is divided in sections to facilitate the cleaning of the parts and its mounting reduces clogging cleaning times. The last advantage to be mentioned is that the die of the present invention has a large orifice which helps the material to flow in a short amount of time, reducing the cutting force (friction) and the pressure on the back of the die, maintaining a low output temperature without expanding the material.

V.—The state of the technique of the patent application WO2017015003 describes a food or meal processing system that includes an extruder and a down current processor. The processors include an elongated processing barrel that features an internal surface with a body or central tube within the barrel and an external surface. These surfaces define a processing an elongated annular processing region. The barrel and tube are heated using steam by means of a device. A rotational processing element is situated inside the region. The element has a plurality of helical vanes, which scrape the surfaces to avoid the accumulation of material on these surfaces. The aforementioned patent application combines an extruder and a processor, unlike the present invention in which the novelty resides in the configuration of the screws due to the spacing between threads, depth and angle of the threads along the screws. In addition, the barrel is divided in sections to facilitate the cleaning of the parts and its mounting reduces clogging cleaning times. The last advantage to be mentioned is that the die of the present invention has a large orifice which helps the material to flow in a short amount of time, reducing the cutting force (friction) and the pressure on the back of the die, maintaining a low output temperature without expanding the material.

VI.—The state of the technique of the patent application WO2003009982 refers to a set of twin extrusion screws characterized in that it comprises: two elongated screws, each one has an elongated central fighting that presents a posterior extreme of the fighting, a frontal extreme of the fighting and a longitudinal axis, a helical flight that extends outward along the length of the central shaft. The flight has a posterior extreme, a frontal extreme, an external surface spaced from the central tree and defines a flight depth between the external flight surface and the central tree, each one of the trees are progressively used along the length thereof through a first sharpening angle from a point adjacent to the frontal extreme of the tree, the flight depth over each tree is progressively used along the length thereof through a second sharpening angle from a site adjacent to the posterior extreme of the flight to the site adjacent to the frontal extreme of the flight, in such a wat that the depth of flight adjacent to the posterior extreme of the flight is bigger than the depth of flight adjacent to the frontal extreme of the flight, the first and second screws are located in relation from side to adjacent side and each one oriented in an angle relative to the adjacent screw, in such a way that the longitudinal axis of the first and second screws define an angle included the first and second screws are configured to rotate together. The aforementioned patent application and the present invention differ in the configuration of the screws, as they have different spacing between the threads, depth and angle between the threads along the screw. Additionally, the barrel is divided in sections to facilitate the cleaning of the parts and its mounting reducing clogging cleaning times. Another advantage to be mentioned is that the die of the present invention has a large orifice which has an area equivalent to 50% to 60% of the barrel discharge, and it helps the material to flow in a short amount of time, reducing the cutting force (friction) and the pressure on the back of the die, maintaining a low output temperature without expanding the material.

VII.—The state of the technique of the patent application WO 9803088 describes cooking devices through short longitude extrusion that include a relatively short barrel that has an input and an extrusion nozzle. A rotating screw assembly, axially cantilevered helically, is positioned within the barrel, and is coupled to driving means for the rotation of the assembly at as speed of at least about 500 revolutions per minute. The device may include a flow restricting device, punctured, that defines a strangulation point in the middle of the barrel for the processed material. An alternative extruder is configured without a restriction in the middle of the barrel and is designed to operate at an essentially atmospheric internal pressure in most of the length of the barrel, with a significant pressure rise in the final tip adjacent to the extrusion nozzle. The aforementioned patent application may include a puncture flow restricting device, that defines a strangulation in the middle of the barrel for the processed material, while the present invention does not feature this characteristic. Another difference is that the present invention features an arrangement of screws that have different spacing between the threads and angles along the screw. Additionally, the barrel is divided in sections to facilitate the cleaning of the parts and its mounting reduces clogging cleaning times. The last advantage to be mentioned is that the die of the present invention has a large orifice which helps the material to flow in a short amount of time, reducing the cutting force (friction) and the pressure on the back of the die, maintaining a low output temperature without expanding the material.

VIII.—The state of the technique of the patent application EP2380441A2 describes a dough extruder that is configured to provide a continuous string of dough adequate for cracker products using a low friction straight compression chamber and a plate matrix oriented perpendicularly to a laminar flow of dough. The extruder can have a compression force sufficient to extrude a plastic mass in a laminar flow in the interval of approximately less than 120 psi; a compression chamber that provides an interior friction coefficient within the interval of approximately 0.2 to 0.35; and a plate matrix horizontally aligned with the longitudinal axis of the compression force. The aforementioned patent application is different to the present invention as it was designed to provide a continuous string of dough adequate for cracker products, while the present invention features a screw arrangement that are spaced differently and has an angle between the threads along the screw. Additionally, the barrel is divided in sections to facilitate the cleaning of the parts and its mounting reduces clogging cleaning times. The last advantage to be mentioned is that the die of the present invention has a large orifice which helps the material to flow in a short amount of time, reducing the cutting force (friction) and the pressure on the back of the die, maintaining a low output temperature without expanding the material.

IX.—The state of the technique of the thesis “Efecto del proceso de nixtamalización sobre el contenido de carotenoides en diferentes híbridos de maíz”. In this work, the maize was crushed in a mill and was subsequently mixed with food grade calcium hydroxide. Afterwards, distilled water was added to reach a 28% humidity using a sprinkler. They were then stored at 4° C. for 12 hours. The next step was processing the material in a single screw extruder with a screw that has 19 mm of diameter and 38 cm of length at a feeding velocity of 70 g/min. The resulting extrudates were cooled and dried in the dark at room temperature for 16 hours to be then crushed in a single screw mill, and were then milled in another mill to produce particles smaller than 0.5 mm. The aforementioned thesis is different as it describes a process, while the present invention is just an extruder. Adding to this, the thesis used a single screw extruder, while the present invention is a double screw extruder with a spacing arrangement between the threads and angles that vary along the screws. Thus, they are different.

X.—The state of the technique of the article “Efecto de la xilanasa en el maíz nixtamalizado extruido harina y tortilla: características reológicas y fisicoquímicas”. In this article the following process was described: white maize was cleaned in a vibrating cleaner, consequently the maize was milled in a mill with a 0.8 mm sieve, afterwards the milled maize is mixed with 0.3% (p/p) of food grade lime in a mixer for 5 minutes. The previously water deluded deionized xylanase was immediately added to the mixture to reach a final humidity content of 30%. Then the mixture was stored for 12 hours at 5° C. Before the extrusion, each mixture was tempered to 25° C. for four hours. The extrusion was done in a single screw extruder, with a screw diameter of 19 mm and a length-diameter relation of 25:1, a nominal compression relation of 2:1, a die opening of 3 mm and four heating and cooling zones. The screw velocity was 112 rpm, the temperature stages were 60° C., 70° C., 80° C. and 90° C. The extrudate was dried in a tunnel dryer at 65° C. for an hour, then it was milled in a mill with a sieve of 0.8 mm. In contrast with the aforementioned article, the proposed invention is not a process. Additionally, the article used a single screw extruder, while the present invention is a double screw extruder, with a screw arrangement that has different spacing and angle between threads along the screw. Additionally, the barrel is divided in sections to facilitate the cleaning of the parts and its mounting reduces clogging cleaning times. Another advantage to be mentioned is that the die of the present invention has a large orifice which helps the material to flow in a short amount of time, reducing the cutting force (friction) and the pressure on the back of the die, maintaining a low output temperature without expanding the material.

XI.—The state of the technique of the thesis “Nixtamalización por extrusión de las fracciones del grano de maíz para la obtención de harinas instantáneas” which describes the following process: the grain underwent a soaking process for 17 minutes at a water temperature of 40° C., subsequently the water was removed by draining it for 10 minutes, then they go through a dehuller at a speed of 800 rpm. Consequently, the fractions were subjected to a separation process with a pneumatic equipment where the endosperm is separated and in another tip side, the germ and pericarp. Afterwards, they were subjected to a vacuum stove at 60° C. for 12 hours. Then, they went through a milling process in a hammer with 0.25 mm circular hole sieves. Consequently, a single screw extruder was employed, the extruder velocity was 50 rpm, which had three stages. The equipment specifications were a worm drive of 95° C., 6 cm of diameter and a compression relation of 1:1. The output of the extruded material was regulated by a circular matric with 1.905 cm of diameter, where the material was cut in pieces of 2 cm to 3 cm of length to facilitate the drying process. It was then dried in trays at a temperature of 60° C. for 12 hours. After the drying of the sample, they were subjected to a milling with a micro pulverizer with a 0.25 mm sieve. The aforementioned thesis is a process, while the present invention is just an extruder. Additionally, the thesis employs a single screw extruder, while in the present invention the extruder uses two screws with an arrangement of different spacing and angle between the threads along the screw. Additionally, the barrel is divided in sections to facilitate the cleaning of the parts and its mounting reduces clogging cleaning times. An advantage to be mentioned is that the die of the present invention has a large orifice which helps the material to flow in a short amount of time, reducing the cutting force (friction) and the pressure on the back of the die, maintaining a low output temperature without expanding the material.

XII.—The state of the technique of the patent application MX/a/2020/001704 which comprises the following stages: clean the grains, hydrate the grains, polish, dry fibers fractions, sift fibers fractions, mill, hydrate endosperms, degerm, mill with 5 roller banks and sift, nixtamalize endosperms of uniform size, extrude, mix, mill and instantly dehydrate, cool, add milled germ and pericarp, sift, remill, and store. The aforementioned patent application is a process while the present invention is an extruder. Thus, they are different. Additionally, the extruder in the present invention features two screws with an arrangement of spacing between threads and angles that vary along the screws, so they are different. Adding to this, the barrel is divided in sections to facilitate the cleaning of the parts and its mounting reduces clogging cleaning times. Finally, another advantage to be mentioned is that the die of the present invention has a large orifice which helps the material to flow in a short amount of time, reducing the cutting force (friction) and the pressure on the back of the die, maintaining a low output temperature without expanding the material.

XIII.—The state of the technique of the patent application MX/a/2020/001968 which comprises a nixtamalized maize flour production process and takes place through the steps: clean the grains, hydrate grains, polish, dry fibers fractions, sift fibers fractions, mill pericarp and germ, nixtamalize, extrude, mill and instantly dehydrate, cool, add milled germ and pericarp, sift, remill, and store. The aforementioned patent application is a process while the present invention is an extruder. Thus, they are different. Additionally, the extruder in the present invention features two screws with an arrangement of spacing between threads and angles that vary along the screws, so they are different. Adding to this, the barrel is divided in sections to facilitate the cleaning of the parts and its mounting reduces clogging cleaning times. Another advantage to be mentioned is that the die of the present invention has a large orifice which helps the material to flow in a short amount of time, reducing the cutting force (friction) and the pressure on the back of the die, maintaining a low output temperature without expanding the material.

### BIBLIOGRAPHY

Scheel, C. 2016. Beyond sustainability. Transforming industrial zero-valued residues into increasing economic returns. Journal of Cleaner Production, 131, 376-386. Justo-Torres, O. & William, P. 2006. Tecnología de extrusióñ en alimentos. Ciencia y Tecnología de los alimentos, 6(3), 78-86.

### BRIEF SUMMARY THE INVENTION

The extruder to nixtamalize maize fraction comprises: a barrel (1) that has four sections: coupling (2), feeding (3), transition (4), and die (5). In the center of the bases of the barrel, it has an elongated perforation (6) in the shape of an eight that extends from the coupling section to the transition. There are two twin screws (7) in the perforation, the screws are moved by a transmission (8) that moves the motor (9). The extruder to nixtamalize maize fractions has as objective to provide an extruder to nixtamalize maize fractions that have been previously conditioned with water and food grade lime, eliminating the production of nejayote in the production of nixtamalized maize flour. The extruder to nixtamalize maize fractions produces the extruded material without expanding at an intermediate humidity (25%-30%). The novelty of this invention is the configuration of the twin screws and the die. Both the screws have threads that are uniform in thickness and depth, but have a different step in length and angle, this configuration produces four sections in the screws. The first two sections are for transport, the third is for mixing and the fourth is for material compression. The second novelty is that the die features a circular orifice that has an area equivalent to 40% to 50% of the discharge of the barrel. With the abovementioned characteristics for the screws and die, it's achieved that the material flows in a short amount of time, reducing the cutting force (friction) and the pressure at the back of the die, maintaining a low temperature and pressure at the output of the extruder without expanding the material. Another advantage of this screws and die configurations is that it improves the properties of the extruded material that will be converted into nixtamalized maize flour. Another novelty to be mention is that the barrel is sectioned, which brims the advantage of a quick disassembly, reducing the cleaning times. Finally, the shape of the extruding die is new, as it has a big output diameter so that the extruded material does not expand, this causes better properties in the production of nixtamalized maize flour.

### BRIEF DESCRIPTION OF THE SEVERAL VIEWS OF THE DRAWING

FIG. 1 shows the lateral view of the extruder to nixtamalize maize fractions.

FIG. 2 shows the internal section of the extruder die to nixtamalize maize fractions.

FIG. 3 shows the top view of the coupling and feeding section of the extruder to nixtamalize maize fractions.

FIG. 4 shows the frontal view of the cannon perforation in the transition section of the extruder to nixtamalize maize fractions.

FIG. 5 shows the screw of the extruder to nixtamalize maize fractions.

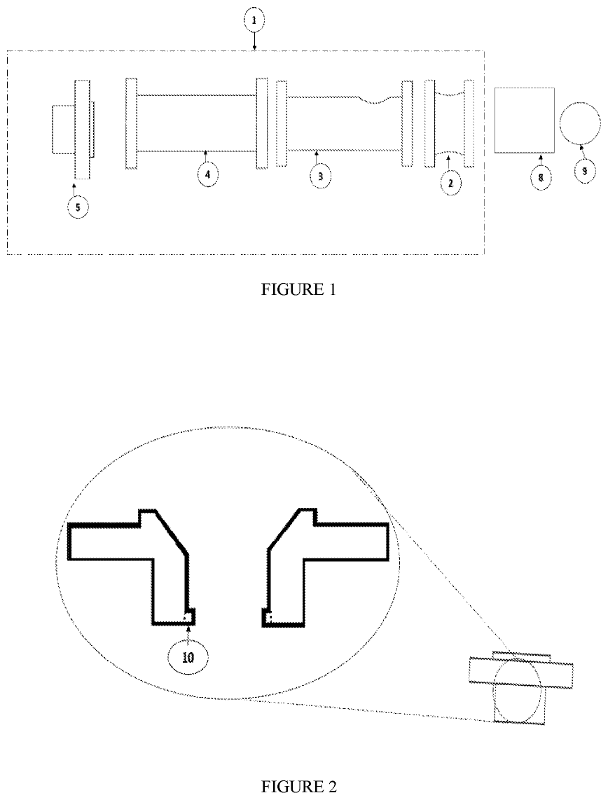

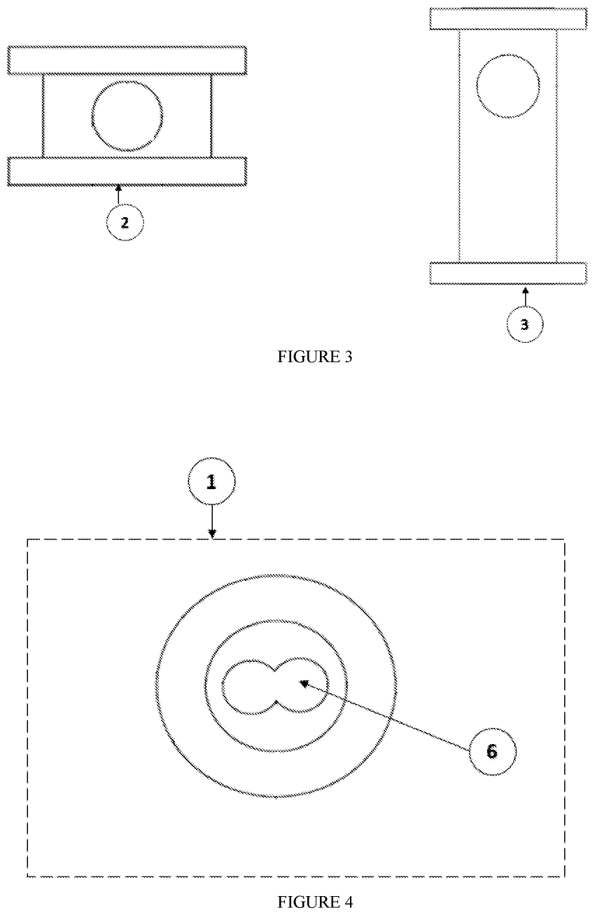

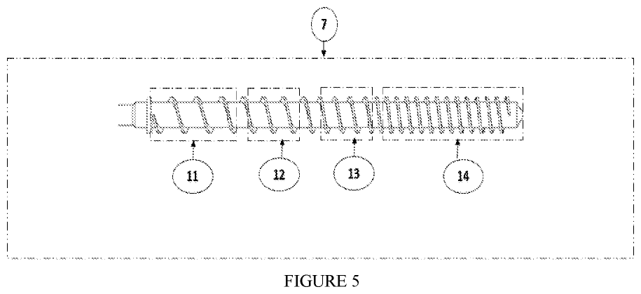

### DETAILED DESCRIPTION OF THE INVENTION

The utility model refers to an extruder to nixtamalize maize fractions, where the extruder comprises a barrel (1) that has four sections: coupling (2), feeding (3) and die (5). The advantage of selecting the barrel is that the parts can be quickly shown, this brings a decrease in the time used for cleaning and maintaining the equipment. When selecting the barrel, the sections are joined by flanges. The barrel has an elongated perforation (6) in the shape of an eight that extends from the coupling to the transition section. In the perforation, two twin screws (7) are found, the screws are moved by a transmission (8) that moves a motor (9). The barrel has a length from 125 cm to 170 cm and from 14 cm to 18 cm of diameter. The coupling section (2) has a length of 8 cm to 12 cm not including the thickness of the flanges and has two flanges at the ends with a diameter of 23 cm to 30 cm, while the thickness of the flanges is of 3 cm to 4 cm. Two circular perforations are found in the coupling section, one at the top and another at the bottom, with a diameter of 7.5 cm to 10 cm, which are aligned and allow the mechanical coupling of the screws. The coupling section is joined by the flanges to the feeding section. The feeding section has a length of 35 cm to 45 cm not including the thickness of the flanges and has two flanges with 35 cm to 45 cm of diameter, while the thickness of the flanges is between 3 cm to 4 cm. The feeding section has a circular orifice at the top, with a diameter of 10 cm to 14 cm located between 4 cm to 6 cm after the flange. This orifice serves for feeding the material to be extruded. The extruder to nixtamalize maize fractions can process from 4.5 kg to 6 kg per minute. It's important to mention that the feeding rate must be lower that 80% of the capacity of the extruder measured in terms of amperage of the transmission motor and velocity of the screws, at a constant flow. To facilitate the feeding to the extruder to nixtamalize maize fractions, a dispenser can be coupled to feed the quantity of material to be extruded in the feeding section. The types of dispenser that can be coupled are volumetric or gravimetric. The feeding section joins the transition section by flanges. The transition section has a length of 35 cm to 45 cm not including the thickness of the flanges and has two flanges with a diameter of 23 cm to 30 cm and a thickness of 3 cm to 4 cm. In the transition section heat can be added by band-type electric resistors that surround this section with the objective of compensating for the temperature at the final section of the barrel. The transition section is joined to the die (5) section by flanges. The die section is coupled to the transition section by a flange that has a thickness of 3 cm to 4 cm and a diameter of 23 cm to 30 cm. The die has a cylindrical shape, and two sprocket hubs of different heights protrude from it, one on each side. The input sprocket hub is the lowest and it's found in the input of the die, has a cylindrical shape and a length of 5 to 10 mm. The input sprocket hub has an exterior diameter of 14 cm to 23 cm, which the interior diameter is of 5 cm to 13 cm. The input sprocket hub has an orifice with conic shape that reaches up to 60% of the die longitude, afterwards the orifice has a cylindrical shape up until coming out through the output sprocket hub. The output sprocket hub is the highest, and it's found in the discharge of the die (also known as output), it has a cylindrical shape and a height of 25 cm to 50 cm. The exterior diameter of the output sprocket hub is of 12 to 20 cm, while the interior diameter is of 5 cm to 11 cm. The output sprocket hub has an obstruction (10) in its interior diameter that has the shape of a ring, the ring has a thickness of 3 mm to 5 mm with a depth of 6 mm to 10 mm and an internal diameter of 4 dm to 10 cm. The internal diameter of the obstruction is smaller than the internal diameter of the output sprocket hub. When the extruded material is forced through the die, pressure is released causing a loss in humidity and a drop in the temperature of the extrudate. The die serves primarily as a resistance to flow. In this case, as the die of the extruder to nixtamalize maize fractions has a big diameter, the change in pressure causes a change in temperature of around 5° C. The circular orifice of the die is equivalent to 40% to 50% of the perforation area (6) elongated in the shape of an eight (also known as the discharge of the barrel). The pressure at the back of the die is of 1 kg/cm² to 1.3 kg/cm², while the output temperature is between 55° C. to 70° C. As mentioned, the die features a big output diameter which causes the extruded material to loss humidity and a decrease in temperature when passing through the die. Additionally, it causes better organoleptic properties and the decrease of clogging in the barrel, this feature brings with it a novelty. A cutter can be couples to the output of the die with the objective of cutting the extruded material in small granules to particles with a maximum length of 7 mm. The cutter is mounted outside the die, which has 2 to 4 blades that pass through the face of the die. For a good cut, the blades must be held rigidly close to the die. Regarding the perforation at the base of the cannon, it has a constant area of transversal section. This perforation come from the coupling section to the transition. The diameter of the circles that make up the eight in the perforation are of 5 cm to 8 cm and the distance between the center of the circles that make up the eight is from 5 cm to 8 cm. With respect to the screws, they are from 2 cm to 6 cm in diameter and their length is from 80 cm to 120 cm. The screws feature a helical thread that goes along the length of the screw, the thickness of the thread is of 3 mm to 9 mm and its depth is of 7 mm to 12 mm. The thickness and depth of the thread is constant along the screw. The threads of the screws are placed interspersed along the entire length of the screws, adding to this the two screws rotate axially in opposite directions. The screws have the function of transporting the product forward, mixing, generating, and transferring heat, in addition to generating texture, pressure, and homogenization. The screw is divided in four sections, the first two sections are fore transport of the material, the third for mixing, and the fourth for compression of the material. The pumping efficiency (transport of the material along the cannon) is affected by the geometry of the screw (pitch, thread angle, depth, etc.). Next, the geometries of the sections are described. The first section (11) of the screw has a longitude of 15 cm to 20 cm, while the spacing between the threads is of 50 mm to 70 mm and the angle of the thread is of 106 degrees to 109 degrees. In the second section (12) the length is of 18 cm to 23 cm, while the spacing between the threads is of 40 mm to 60 mm and the angle is of 102 degrees to 105 degrees. In the third section (13) the length is of 12 cm to 16 cm, while the spacing between the threads is of 35 mm to 40 mm and the angle of the thread is of 98 degrees to 102 degrees. In the fourth section the cutting phenomenon is created, which makes the product stretch, accelerates gelatinization of the starches and other reactions, aligns long chain molecules, and can depolymerize them (causing dextrinization). In this section, three temperature stages are reached, one being of 40° C. to 50° C., another of 50° C. to 60° C. and one of 60° C. to 70° C. The main novelty is the configuration of the screws and die. The two screws have threads uniform in thickness and depth, but the spacing between the threads and the angle varies along the screw. The aforementioned characteristics cause four sections to be generated along the screw. The first two sections are for transport, the third for mixing, and the fourth for compression. Another novelty is that the die features a circular orifice that has an area equivalent to 40% to 50% of the elongated perforation (6) in the shape of an eight. Together, screws and die, help the material flow in a short amount of time, reducing the cutting force (friction) and the pressure at the back of the die, maintaining a low temperature at the output of the extruder without expanding the material.

### Use Cases:

The extruder to nixtamalize maize fractions was employed in the following manner, first a mixture of degermed maize grain fractions was conditioned, previously conditioned with hot water at 80° C. to 95° C. and calcium hydroxide of 0.1% to 0.15% for a two-hour to three-hour period of rest. The mixture of degermed maize grain fractions has the following proportions: the endosperm represents from 65% to 75% of mass; while the dark flours, from 10% to 15%; and the milled germ and pericarp, from to 10% to 15%. The humidity of the mixture does from 25% to 35% and its temperature after the rest goes from 35° C. to 50° C. This mixture was processed in the extruder to nixtamalize maize fractions. Next, the components of the extruder to nixtamalize maize fractions are described, the barrel of the extruder had four sections: coupling, feeding, transition and die. In the center of the bases of the barrel a perforation in the shape of an eight is located, it extends from the coupling section to the transition. The screws are moved by a transmission that moves the motor. The length of the barrel was 128 cm while its diameter was 15 cm. In this case, the coupling section was of 9.6 cm, while the thickness of the flanges was 3 cm, and the diameter was 27 cm. The diameter in the perforations of the coupling section was 7.95 cm. The coupling section was joined to the feeding section by a flange. The feeding section had a length of 40.43 cm, while the thickness of the flanges was 3.55 cm, with respect to the diameter of the flanges, it was 27 cm. The diameter of the circular orifice of the feeding section was 10.8 cm and it was position in the top part 4.5 cm away from the flange. The feeding section was joined to the transition section by a flange. The transition section had a length of 40 cm, while the thickness of the flanges was 3.5 cm, and the diameter of the flanges was 27 cm. The transition section is connected to the die section by a flange of 3.5 cm of thickness while its diameter was 27 cm. The die had a cylindrical shape and two sprocket hubs of different height protruded from it, one on each side. The input sprocket hub was the lowest and had a cylindrical shape and a length of 8 mm. The input sprocket hub was joined to the transition section of the barrel. The external diameter of the input sprocket hub was 15 cm, while the internal diameter was 6.8 cm. The input sprocket hub had a conic shaped orifice that reached up to 60% the length of the die, to then come out in a cylindrical shape until coming out through the output sprocket hub. The output sprocket hub had a cylindrical shape and a height of 40 mm. The output sprocket hub had an exterior diameter of 13 cm while the interior diameter was 6.8 cm. The output sprocket hub had an obstruction in its internal diameter that had the shape of a ring, the ring had a thickness of 4 mm with a depth of 9 mm. The internal diameter of the ring was 6 cm. The circular orifice that the die had was equivalent to 40% of the elongated perforation in the shape of an eight. In the perforation at the bases of the barrel, the diameter of the circles that make up the eight in the perforation was 6.5 cm. The diameter of the screws war 4.44 cm and its length was 81 cm. The helical thread had a thickness of 6.35 mm and a depth of 9.52 mm. The threads were interspersed along the screw. The screw was divided in four sections, the first had a length of 18.09 cm and the spacing between the threads was 60 mm with an angle of 107.6 degrees of the thread. The second section of the screw had a length of 19.05 cm and the spacing between the threads was 48 mm with an angle of 10.4 degrees. The third section had a length of 14.28 cm, with spacing between the threads of 36 mm and an angle of 100.7 degrees. Finally, the fourth section had a length of 33.57 cm, with spacing between the threads of 24 mm and an angle of 97 degrees. In the fourth section, three heating stages are reached, 40° C., 50° C., and 60° C. Once the material passes through the die it reaches a pressure of 1 kg/cm² to 1.3 kg/cm² at a temperature of 55° C. to 70° C. Once the material passed through the extruder, the extrudate was then cut in small pieces at a maximum of 7 mm, with a cutter of four blades. After the extrudate was cut, it was cooled to temperatures below 60° C. The cooling took place through a pneumatic process. The humidity of the extrudate was in a range between 25% and 30%. The extrudate was milled with a BCH roller mill (micropulverizer). Afterwards, it was instantly dehydrated with a flow of hot air in a range of 200° C. to 400° C. This hot air was transported through a pipe in which the diameter was reduced, decreasing its pressure, and increasing its speed (Venturi effect) until the milled and dehydrated extrudate reached a temperature between 30° C. to 35° C., by means of a pneumatic transport using room temperature air. Afterwards, the mixture passed to the sifting process, were the flour had the following granulometric characteristics: with a sieve of 0.60 mm (US #30) it retained no particles, with a sieve of 0.425 mm (US #40) it retained a maximum of 15%, with a sieve of 0.250 mm (US #60) it retained a maximum of 6%, with a sieve of 0.150 mm (US #100) it retained a maximum of 90%. The flour that did not comply with the granulometry was remilled and integrated to the sifting. The color characteristics of the produced flour were the following: dry color of 84% reflectance and humid color of 40% reflectance, while the humidity was at 7%, and 6.3 pH. The efficiency of flour to produced dough when adding water to a kilogram of flour was 2.3 kilograms of dough.

1. The extruder to nixtamalize maize fractions, characterized in that it comprises: a barrel (1) that has four sections: coupling (2), feeding (3), transition (4), and die (5), from the coupling section to the transition, the cannon has an elongated perforation (6) in the middle of the bases of the barrel in the shape of an eight, inside the perforation two twin screws (7) are found, the screws are moved by a transmission (8) that moves a motor (9).

2. The extruder to nixtamalize maize fractions in conformity with claim 1 characterized in that the barrel (1) has a length of 125 cm to 170 cm and the diameter is of 14 cm to 18 cm.

3. The extruder to nixtamalize maize fractions in conformity with claim 1 characterized in that the coupling (2) section has a length of 8 cm to 12 cm not including the thickness of the flanges and has two flanges at the extremes with a diameter of 23 cm to 30 cm while the thickness of the flanges is 3 cm to 4 cm.

4. The extruder to nixtamalize maize fractions in conformity with claim 1 characterized in that the coupling (2) section has to circular perforations, one on the top and the other at the bottom with a diameter of 7.5 cm to 10 cm, which are aligned.

5. The extruder to nixtamalize maize fractions in conformity with claim 1 characterized in that the coupling (2) section is joined to the feeding section by flanges.

6. The extruder to nixtamalize maize fractions in conformity with claim 1 characterized in that the feeding section has a length of 35 cm to 45 cm not including the thickness of the flanges and has two flanges with a diameter of 23 cm to 30 cm, while the thickness of the flanges is 3 cm to 4 cm.

7. The extruder to nixtamalize maize fractions in conformity with claim 1 characterized in that the feeding (3) section has a circular orifice at the top with a diameter of 10 cm to 14 cm located from 4 cm to 6 cm after the flange.

8. The extruder to nixtamalize maize fractions in conformity with claim 1 characterized in that the feeding (3) section can be coupled with a dispenser that can be volumetric or gravimetric.

9. The extruder to nixtamalize maize fractions in conformity with claim 1 characterized in that the feeding (3) section must be fed at least 80% of the capacity of the extruder, measured in terms of amperage of the motor of the transmission and velocity of the screws.

10. The extruder to nixtamalize maize fractions in conformity with claim 1 characterized in that in the feeding (3) section 4.5 kg to 6 kg per minute can be processed.

11. The extruder to nixtamalize maize fractions in conformity with claim 1 characterized in that the feeding (3) section is joined to the transition (4) section by flanges.

12. The extruder to nixtamalize maize fractions in conformity with claim 1 characterized in that the transition (4) section has a length of 35 cm to 45 cm not including the thickness of the flanges and has two flanges with a diameter of 23 cm to 30 cm and a thickness of 3 cm to 4 cm.

13. The extruder to nixtamalize maize fractions in conformity with claim 1 characterized in that the transition (4) section can add heat by means of band type electrical resistors that surround this section.

14. The extruder to nixtamalize maize fractions in conformity with claim 1 characterized in that the transition (4) section is joined to the die (5) section by a flange that has a thickness of 3 cm to 4 cm and a diameter of 23 cm to 30 cm.

15. The extruder to nixtamalize maize fractions in conformity with claim 1 characterized in that the die (5) section has a cylindrical shape and two sprocket hubs of different heights protrude from it, one on each side.

16. The extruder to nixtamalize maize fractions in conformity with claim 1 characterized in that the die (5) section has two sprocket hubs, one of input and another for output.

17. The extruder to nixtamalize maize fractions in conformity with claim 16 characterized in that the input sprocket hub is joined to the transition (4) section of the barrel.

18. The extruder to nixtamalize maize fractions in conformity with claim 16 characterized in that the input sprocket hub has a length of 5 mm to 10 mm.

19. The extruder to nixtamalize maize fractions in conformity with claim 16 characterized in that the input sprocket hub has an external diameter of 14 cm to 23 cm, while the internal diameter is 5 cm to 13 cm.

20. The extruder to nixtamalize maize fractions in conformity with claim 1 characterized in that the input sprocket hub has a conical shaped orifice that reaches up to 60% of the length of the die, afterwards orifice has a cylindrical shape until coming out through the output sprocket hub.

21. The extruder to nixtamalize maize fractions in conformity with claim 16 characterized in that the output sprocket hub has a cylindrical shape and a height of 25 mm to 50 mm.

22. The extruder to nixtamalize maize fractions in conformity with claim 16 characterized in that the output sprocket hub has an external diameter of 12 cm to 20 cm, while the internal diameter is 5 cm to 11 cm.

23. The extruder to nixtamalize maize fractions in conformity with claim 16 characterized in that the output sprocket hub has and obstruction (10) in its internal diameter that had the shape of a ring, the ring has a thickness of 3 mm to 5 mm with a depth of 6 mm to 10 mm and an internal diameter of 4 cm to 10 cm.

24. The extruder to nixtamalize maize fractions in conformity with claim 16 characterized in that the output sprocket hub has an internal diameter bigger than the obstruction.

25. The extruder to nixtamalize maize fractions in conformity with claim 1 characterized in that the die (5) section has a circular orifice that has an area equivalent to 40% to 50% of the elongated perforation (6) area in the shape of an eight.

26. The extruder to nixtamalize maize fractions in conformity with claim 1 characterized in that after the die (5) section the pressure is 1 kg/cm² to 1.3 kg/cm² while the temperature is at 55° C. to 70° C.

27. The extruder to nixtamalize maize fractions in conformity with claim 1 characterized in that at the die (5) section a cutter may be coupled. The cutter has 2 to 4 blades that pass through the face of the die.

28. The extruder to nixtamalize maize fractions in conformity with claim 1 characterized in that the perforation (6) at the bases of the barrel (1) that goes from the coupling (2) section to the transition (4) section has a constant transversal section.

29. The extruder to nixtamalize maize fractions in conformity with claim 1 characterized in that the perforation (6), the diameters of the circles that make up the eight are 5 cm to 8 cm.

30. The extruder to nixtamalize maize fractions in conformity with claim 1 characterized in that in the perforation (6) the distance from the center of the circles that make up the eight is 5 cm to 8 cm.

31. The extruder to nixtamalize maize fractions in conformity with claim 1 characterized in that the screws have a diameter of 2 cm to 6 cm and a length of 80 cm to 120 cm.

32. The extruder to nixtamalize maize fractions in conformity with claim 1 characterized in that the screws have a helical thread along the screw, the thickness of the thread is 3 mm to 9 mm and its depth is 7 mm to 12 mm.

33. The extruder to nixtamalize maize fractions in conformity with claim 1 characterized in that the two screws are place interspersed along the entire length of the screws and rotate axially in opposite directions.

34. The extruder to nixtamalize maize fractions in conformity with claim 1 characterized in that the screws are divided in four sections.

35. The extruder to nixtamalize maize fractions in conformity with claim 34 characterized in that the length of the first section (11) is 15 cm to 20 cm, while the spacing between the threads is 50 mm to 70 mm and the angle of the thread is 106 degrees to 109 degrees.

36. The extruder to nixtamalize maize fractions in conformity with claim 34 characterized in that the length of the second section (12) is 18 cm to 23 cm, while the spacing between the threads is 40 mm to 60 mm and the angle of the thread is 102 degrees to 105 degrees.

37. The extruder to nixtamalize maize fractions in conformity with claim 34 characterized in that the length of the third section (13) is 12 cm to 16 cm, while the spacing between the threads is 35 mm to 40 mm and the angle of the thread is 98 degrees to 102 degrees.

38. The extruder to nixtamalize maize fractions in conformity with claim 34 characterized in that the length of the fourth section (14) is 30 cm to 35 cm, while the spacing between the threads is 23 mm to 28 mm and the angle of the thread is 90 degrees to 100 degrees.

39. The extruder to nixtamalize maize fractions in conformity with claim 34 characterized in that in the fourth section (14), three heating stages are reached: one of 40° C. to 50° C., another of 50° C. to 60° C., and another of 60° C. to 70° C.
